(19) United States
(12) Patent Application Publication
(10) Pub. No.: US 2007/0086177 A1
(43) Pub. Date: Apr. 19, 2007

(54) Tapered tophat lighting fixture shade

(75) Inventor: Jeff Mateer, Fort Wayne, IN (US)

Correspondence Address: BARNES & THORNBURG LLP, P.O. BOX 2786, CHICAGO, IL, 60690-2786, US

(73) Assignee: Apollo Design, Fort Wayne, IN (US)

(21) Appl. No.: 11/549,244

(22) Filed: Oct. 13, 2006

Related U.S. Application Data
(60) Provisional application No. 60/727,067, filed on Oct. 14, 2005.

(51) Int. Cl. G03B 15/02

(52) U.S. Cl. 362/18

(57) ABSTRACT

A shade, for use with a theatrical or architectural lighting fixture. The lighting fixture having a slot configured to receive the shade. The shade includes a frustoconical tube having a side wall defining a central opening and having a larger end and a smaller end, a base plate disposed about the larger end of the frustoconical tube, and a plurality of stops located within the central opening. The stops are configured to allow releasable nested stacking of multiple shades.

### BACKGROUND

The present disclosure relates to an accessory for a theatrical lighting fixture. In particular, a tubular shade that attaches to the front of the lighting fixture to direct light and relieve glare. Such a shade is commonly known as a tophat. This name most likely originates with the physical features of the device looking very similar to a gentleman's dress hat.

The function of the tophat is two-fold. First, the tophat directs light into a cylindrical beam, reducing and/or eliminating dispersion of light onto nearby subjects. This prevents tight radiating off the front of the fixture from illuminating scenery, ceilings or drapery nearby. This light spill can be distracting and can interfere with a performance. Secondly, the fixture of most lighting fixtures is such that the front of the fixture, where a beam of light exits the fixture, can be undesirably bright. When viewed from a side angle the light exiting the fixture can create a glare. Again, this incidental light can distract from the subject the light is intended to illuminate.

The construction of currently available tophats consists of two parts. A round or square flat plate forms the base of the tophat. This base fits into a slot on lighting fixtures common to the industry. Extending from the base plate is a hollow, cylindrical tube, the sides of which are parallel to the opposite side.

There are several manufacturers in the entertainment and architectural industry that produce tophats out of sheet metal or spun aluminum. These tophats create a problem in storage and shipping. The tube of current tophats is such that the sides are parallel to the opposing side. When storing and shipping, the space used is equal to the volume of one tophat. This becomes quite an issue when dozens or hundreds of the tophats are packaged or stored, requiring a huge volume of space.

In addition, tophats constructed with cylindrical parallel-sided tubes are often damaged in transit. This damage is incurred when the weight of many units rests on the tubes of the units near the bottom of the shipment. This results in tubes that are bent out of round or dented beyond repair. It is desirable for a tophat that mates with existing light fixtures in the industry yet is convenient to store and is resistant to damage during shipment.

As used herein, the term “tophat” refers to a shade for a theatrical or architectural lighting fixture as described herein.

### SUMMARY

A tophat of the present disclosure incorporates a tube having a slight taper. This taper allows tophats to nest together. When units are nested together, the volume of space used in storage and shipping is greatly reduced. An added advantage of the nesting operation is that the tubes of nested tophat's protect the tubes of the unit below. This feature greatly reduces the amount of storage and transit damage.

In particular the present disclosure provides a taper between 1 and 5 degrees, although a taper of greater than 5 degrees may be useful in some circumstances. Virtually no loss of light output in the directed beam or additional shaping of the light beam was observed compared to the existing parallel sided tophats.

### BRIEF DESCRIPTION OF THE DRAWINGS

The present disclosure will be described hereafter with reference to the attached drawings which are given as non-limiting examples only, in which;

FIG. 1 is a perspective view of a tophat of the present disclosure;

FIG. 2 is a schematic view of a tophat of the present disclosure affixed to a theatrical lighting fixture projecting a beam of light;

FIG. 3 is a perspective view showing two tophats of the present disclosure in a stacked arrangement;

FIG. 4 detailed view of a stop affixed to the inside surface of the tophat to maintain a releasable nested arrangement;

FIG. 5 is a side view showing two tophats of FIG. 4 in a releasable nested arrangement.

### DETAILED DESCRIPTION

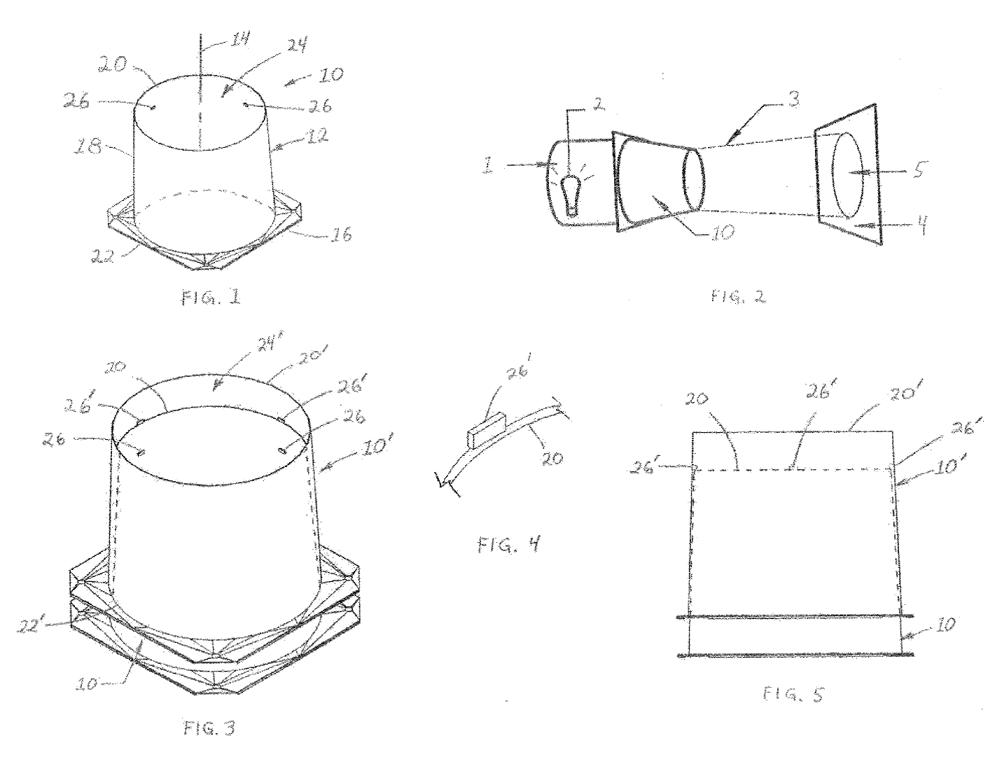

Referring to FIG. 1, the lighting fixture shade 10, or tophat of the present disclosure includes a frustoconical tube 12 having a longitudinal axis 14 and a base 16. The frustoconical tube 12 includes a tapered sidewall 18 having a free edge 20 and a base edge 29. The tapered side wall 18 defining an interior passage 24 therein.

FIG. 2 schematically shows the application of the tophat 10 of the present disclosure in conjunction with a theatrical or architectural lighting fixture 1. Such lighting fixtures are commonly known to those familiar with the art and may embody many dimensional sizes, light output and shapes. A light source 2, which also embodies many dimensional sizes, light output and beam shapes is provided in fixture 1. In operation, the light source 2, in fixture 1, creates a light beam 3 which is directed towards an object or area to be illuminated 4. The tophat 10 of the present disclosure shapes the light beam 3 to provide a sharp distinct, illuminated area 5, without diffusion or glare.

Referring again to FIG. 1, a base 16 is attached to the base edge 22 of the tapered side wall 18. Base 16 is configured to be received within a slotted bracket provided on the outlet of a theatrical and architectural lighting fixture. The frustoconical tube 12 may be joined to base 16 by extending a portion of tapered side wall 18 and folding base edge 22 outward. Bottom edge 22 is folded over base 16 and spot welded to join bottom edge 22 and base 16. Base 16 may also be integrally formed with the tapered side wall 18 and folded perpendicular to axis 14 by stamping or other forming operation known in the art. Alternatively, base 16 may be attached to side wall 18 by welding, brazing, adhesive or other means. Base 16 may be configured having either a square or circular shape.

Tapered side wall 18 is angled inward towards axis 14 by approximately 1 to 5 degrees, although angles of greater than 5 degrees are also acceptable. This results in free edge 20 having a smaller circumference than base edge 22. This enables a number of tophats 10 to be nested inside one another for compact packaging and storage.

The tophat 10 of the present disclosure may also include one or more stops 26 positioned on the inside surface of tapered side wall. The stops 26 are configured to maintain two or more tophats 10 in a stacked nested arrangement, while preventing an interference fit between two adjacent tophats 10. Stops 26 may be formed from sheet metal and spot welded to the inside surface of tapered side wall 18.

As shown in FIGS. 3 to 5, one or more stops 26 are positioned on an inner surface of tapered side wall 18. In an embodiment, four stops 26 are provided, one at each quadrant of the inside circumference of interior passage 24. Tophats 10, 10′ are nested for storage or shipping by inserting the free edge 20 of tapered side wall 18 of a first tophat 10 into the interior passage 24′ of a second tophat 10′ through the opening defined by the base edge 22′. The free edge 20 of the first tophat 10, having a smaller circumference that the base edge 22′ of the second tophat 10′, fits into the interior region 24′ of the second tophat 10′ until the free edge 20 engages stops 26′ allowing tophats 10, 10′ to be nested without the outer surface of side wall 18 and the inner surface of side wall 18′ becoming engaged in an interference fit, thus facilitating stacking and removal.

The following is provided as an illustrative embodiment of the tophat of the present disclosure and in no way is intended to limit the scope of the claimed invention. An embodiment of the present disclosure is constructed of 21-gauge cold rolled steel (CRS) sheet metal. The frustoconical tube 12 is 6.00 inches high, and having a free edge 20 of 6.329 inches outside diameter and a base edge 22 of 6.75 inches outside diameter. Disposed about the base edge 22, is a base 16 measuring 7.50 inches by 7.50 inches square. Stops 26 are fabricated from cold rolled steel and measure 0.250 inches by 0.100 inches by 0.045 inches. Four stops 26 are positioned on the inside surface of tapered side wall 18 at a distance of 1.25 inches below free edge 20 and oriented 90 degrees from each other. The tophat 10 may be powder coated to protect the steel from corrosion. Additionally, black felt flocking may be sprayed onto the inner surface of tapered sidewall 18 to provide a flat finish, reducing reflected light within the interior region 24.

While an embodiment has been illustrated and described in the drawings and foregoing description, such illustrations and descriptions are considered to be exemplary and not restrictive in character, it being understood that only an illustrative embodiment has been shown and described and that all changes and modifications that come within the spirit of the invention are desired to be protected. The applicant has provided description and figures which are intended as an illustration of certain embodiments of the disclosure, and are not intended to be constructed as containing or implying limitation of the disclosure to those embodiments. There are a parality of advantages of the present disclosure arising from various features set forth in the description. It will be noted that alternative embodiment of the disclosure may not include all of the feature described yet still benefit from at least some of the advantages of such features. Those of ordinary skill in the art may readily devise their own implementations of the disclosure and associated methods that incorporate one or more of the feature of the disclosure and fall within the spirit and scope of the present disclosure as defined by the impendent claims.

1. A shade, for use with a lighting fixture including a slot, the shade comprising:
a frustoconical tube having a side wall defining a central opening and having a larger end and a smaller end, and
a base plate disposed about the larger end of the frustoconical tube, the base plate configured to be received by the slot on the lighting fixture.

2. The shade of claim 1 further comprising one or more stops located with the central opening of the frustoconical tube.

3. The shade of claim 1 wherein the side wall of the frustoconical tube is tapered at an angle of at least 1 degree.

4. The shade of claim 1 wherein the side wall of the frustoconical tube is tapered at an angle of less than about 5 degrees.

5. The shade of claim 1 where in the side wall of the frustoconical tube is tapered at an angle between about 1 degree and five degrees.

6. The shade of claim 2 further comprising a powder coat finish.

7. The shade of claim 2 further comprising felt flocking disposed within the central opening.

8. A shade, for use with a lighting fixture including a slot, the shade comprising:
a frustoconical tube having a side wall defining a central opening and having a larger end and a smaller end,
the side wall being tapered at an angle between 1 and 5 degrees,
a plurality of stops located within the central opening, and
a base plate disposed about the larger end of the frustoconical tube, the base plate configured to be received by the slot on the lighting fixture.

9. The shade of claim 8 wherein the perimeter of the base plate is configured as a square.

10. The shade of claim 8 wherein the perimeter of the base plate is configured as a circle.
